(19) United States
(12) Patent Application Publication
(10) Pub. No.: US 2015/0261430 A1
(43) Pub. Date: Sep. 17, 2015

(54) DOCUMENT DATA DISTRIBUTION SYSTEM AND PROGRAM

(71) Applicant: TOSHIBA TEC KABUSHIKI KAISHA, Tokyo (JP)

(72) Inventor: Takahiro HAGIWARA, Chiba Chiba (JP)

(21) Appl. No.: 14/315,761

(22) Filed: Jun. 26, 2014

(30) Foreign Application Priority Data
Mar. 11, 2014 (JP) 2014-048085

(51) Int. Cl. G06F 3/0488

(52) U.S. Cl. CPC G06F 3/04883

(57) ABSTRACT

A document data distribution system includes a distribution unit that distributes document data, an acquisition section, an intersection determination section, and an erase section. The acquisition section acquires a plurality of through points representing a write line drawn to be overlaid on the document data and a plurality of through points representing an erase line for erasing portions of the write line drawn to be overlaid on the document data. The intersection determination section adds a relay point between the through points of the write line and determines two of the through points and relay points of the write line as boundary points of an intersection area where the erase line intersects with the write line.

### CROSS-REFERENCE TO RELATED APPLICATION

This application is based upon and claims the benefit of priority from Japanese Patent Application No. 2014-048085, filed Mar. 11, 2014, the entire contents of which are incorporated herein by reference.

### FIELD

Embodiments described herein relate generally to a document data distribution system and program.

### BACKGROUND

In the related art, a terminal apparatus including a display device equipped with a touch panel has a function of drawing lines or erasing drawn lines through operation of the touch panel by a user. A position for drawing and a position for erasing may be detected by a method of detecting pixels touched by the user or by a method of detecting a trajectory of through points represented as stroke data, made by the user. In the case of managing the position for drawing and the position for erasing using the stroke data, a position at which a drawn line intersects an erase line is specified in units of an area between through points in the drawn line that are subjected to an erase process. Further, in the case of managing the position for drawing and the position for erasing using pixel data, drawn pixels are erased when the drawn pixels overlap erase pixels.

However, since the amount of data increases in the method that uses pixel data, the method is not suitable for data transmitted through a network, files for storage and the like. Further, the method that uses stroke data indicating the plurality of through points has a problem in that a range wider than a width of a line to be erased is erased in accordance with an interval between through points which define the drawn line in an erase process.

### DESCRIPTION OF THE DRAWINGS

FIG. 1 is a diagram illustrating an example of an overall configuration of a distribution system according to an embodiment.

FIG. 2 is a diagram illustrating a configuration example of a server in the distribution system according to the embodiment.

FIG. 3 is a diagram illustrating a process example in the server according to the embodiment.

FIG. 4 is a schematic diagram illustrating a management format of document data and stroke data of a write line and an erase line, according to the embodiment.

FIG. 5 is a diagram illustrating an example of the write line and the erase line on document data displayed on a display device of a user terminal.

FIG. 6 is a diagram illustrating an example of the write line and the erase line which are defined by a plurality of through points.

FIG. 7 is a diagram illustrating an example in which the write line is subjected to an erase process in units of an area between through points.

FIG. 8 is a diagram illustrating an example of relay points added between through points of the write line.

FIG. 9 is a diagram illustrating an example in which the write line is subjected to the erase process in units of an area between through points and an area between relay points.

FIG. 10 is a flow chart illustrating a process of generating a file of a general-purpose format in the distribution system according to the embodiment.

FIG. 11 is a flow chart illustrating an intersection determination process in the distribution system according to the embodiment.

FIG. 12 is a diagram illustrating an example of intersection determination for a plurality of through points and relay points in the write line and the erase line.

FIG. 13 is a diagram illustrating an example of a intersection determination result.

FIG. 14 is a diagram illustrating an example of a write line, a part of which is obtained by the intersection determination result illustrated in FIG. 13 and erased.

FIG. 15 is a diagram illustrating an example in which the write line illustrated in FIG. 13 is represented as a file format.

### DETAILED DESCRIPTION

Embodiments provide a document data distribution system and program which accurately perform drawing and erasing of a line.

In general, according to one embodiment, a document data distribution system includes a distribution unit that distributes document data, an acquisition section, an intersection determination section, and an erase section. The acquisition section acquires a plurality of through points representing a write line drawn to be overlaid on the document data and a plurality of through points representing an erase line for erasing portions of the write line drawn to be overlaid on the document data. The intersection determination section adds a relay point between the through points of the write line and determines two of the through points and relay points of the write line as boundary points of an intersection area where the erase line intersects with the write line.

Hereinafter, embodiments will be described with reference to the drawings.

First, an overall configuration of a print distribution system according to an embodiment will be described.

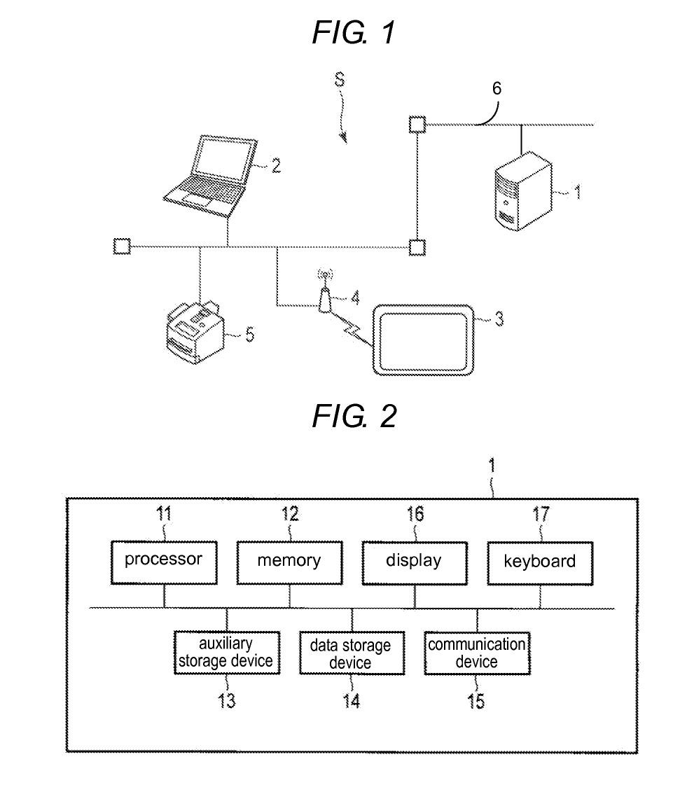

FIG. 1 is a diagram illustrating an example of an overall configuration of a distribution system S according to an embodiment.

In the configuration example illustrated in FIG. 1, the distribution system S includes a server 1, a PC 2, a tablet terminal 3, an access point 4, a multifunction device 5, and the like. The server 1, the PC 2, the tablet terminal 3, the access point 4, and the multifunction device 5 are connected with each other through a network 6.

The server 1 is a computer connected to the network 6. The server 1 has a function of managing document data, display data associated with the document data, and the like. For example, the server 1 has a function of transmitting the document data and data added to the document data (for example, data superimposed on the document data (stroke data which will be described later)) to other apparatuses (the PC 2, the tablet terminal 3, or the multifunction device 5) on the network 6. Further, the server 1 has a function of managing information obtained from respective apparatuses on the network 6.

The PC 2 communicates with the server 1 through the network 6. The tablet terminal 3 is connected to the network 6 through the access point 4 for wireless communication and communicates with the server 1. The PC 2 and the tablet terminal 3 are user terminals to which document data is distributed. The user terminal implemented in the distribution system S is not limited to the PC or the tablet terminal, but may be any apparatus to which document data is distributed from the server 1. In the present embodiment, it is assumed that the PC 2 and the tablet terminal 3 are user terminals each having a display device equipped with a touch panel.

The PC 2 and the tablet terminal 3 are computers including a processor, a memory, a network interface, and a display device equipped with a touch panel. The PC 2 and the tablet terminal 3 achieve various types of functions by a processor executing programs stored in a memory. For example, the PC 2 and the tablet terminal 3 have a function of displaying document data such as the document data distributed from the server 1 on the display device. Further, the PC 2 and the tablet terminal 3 have a function of giving a designated color to a portion touched by the user on the touch panel (pen function) and an erase function of erasing colors which has been given by the pen function in the portion touched by the user on the touch panel (eraser function), in a state where the document data is displayed on the screen.

The PC 2 and the tablet terminal 3 have a function of generating both information indicating a touched position (write position) when the pen function is performed and information indicating a touched position (erase position) when the eraser function is performed, as stroke data. For example, the PC 2 and the tablet terminal 3 have a function of transmitting stroke data detected when the pen function is performed and stroke data detected when the eraser function is performed, in correlation with document data to the server 1, while certain document data is displayed.

The multifunction device 5 includes a system controller, a scanner, a printer, an operation panel, and the like. The system controller is a computer controlling the entire multifunction device. The system controller includes a processor, a memory, a communication interface, and the like. In the system controller, the processor achieves various functions by executing a program stored in the memory.

The scanner scans a document and converts an image of a document surface into image data (document data). The printer forms an image on a sheet. The printer is not limited to any specific type of image forming device, but may be a printer of an electro-photographic type, an ink-jet type or a thermal transfer type. The operation panel includes a display device equipped with a touch panel. The operation panel displays an operation screen for operating the multifunction device.

In addition, the multifunction device 5 may provide the display function, the pen function, the eraser function, and the like of document data similar to those of the PC 2 or the tablet terminal 3, through the operation panel. Further, the multifunction device 5 may be equipped with functions such as the functions of the document data similar to those of the server 1.

In other words, in the distribution system S, the PC 2 and the tablet terminal 3 may write a graphic such as a line which is input by an input device, such as a touch panel, as a memo so as to be superimposed on an image of document data. Further, the graphic such as the line which is written once may be erased by an input by the input device such as the touch panel. Stroke data indicating the line (write line) which is input by the input device such as the touch panel or an erase line indicating an erase portion is managed by being collected and stored in the server separately from the document data. The server 1 transmits the registered original document data and data such as the stroke data of the write line and the erase line accumulated in correlation with the document data to respective devices (a PC, a tablet terminal, a printing device, and the like) on a network and converts the data into a file of a general-purpose format. Thus, in the distribution system S, a plurality of users may share data including stroke data of the write line which has been written into the document data by a specific user.

Next, a configuration example of the server 1 in the distribution system S according to the present embodiment will be described.

FIG. 2 illustrates the configuration example of the server 1 in the distribution system S according to the present embodiment.

In the configuration example illustrated in FIG. 2, the server 1 includes a processor 11, a memory 12, an auxiliary storage device 13, a data storage device 14, a communication device 15, a display 16, a keyboard 17, and the like.

The processor 11 is an arithmetic unit such as a CPU. The memory 12 is a work memory including a RAM and the like. The auxiliary storage device 13 is a nonvolatile memory for storing a program that the processor executes.

The data storage device 14 is a rewritable nonvolatile memory of a large capacity such as a hard disk drive. The data storage device 14 functions as a database for storing document data and data related to management of the document data (stroke data of the write line and the erase line, will be described later) and the like. The communication device 15 is a network interface for connection to the network 6. The display 16 is a display device displaying an image such as management data or the document data and the like. The keyboard 17 is an operation unit for receiving an input from a user such as a system manager.

The processor 11 achieves various functions by reading a program stored in the auxiliary storage device 13 and loading the program in the memory 12 so as to execute the program. For example, the processor 11 performs a registration process of registering document data, a distribution process of distributing the document data, a recording process of recording the stroke data, a file generation process of generating a file of a designated format, and a data (file) generation process of generating data (a file) for printing by executing a program for the distribution system.

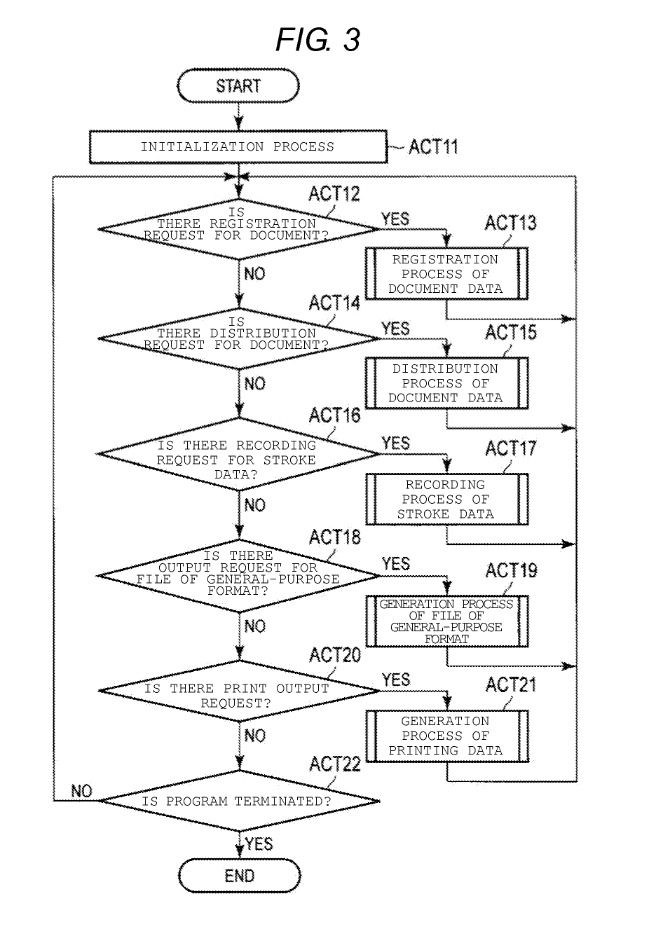

FIG. 3 is a flow chart illustrating a process of the server 1.

If the program for the distribution system is activated, the processor 11 of the server 1 secures a work memory area in the memory 12 and performs an initialization process for an initial setting of various parameters and the like (ACT11). If the initialization process is completed, the processor 11 is in a state capable of performing various processes, and receives a request for various processes.

In other words, when a registration request for document data for distribution is received (YES in ACT12), the processor 11 performs a registration process of the document data for distribution (ACT13). The processor 11 of the server 1 receives the registration request for document data for distribution from devices such as the PC 2, the tablet terminal 3, the scanning device of the multifunction device 5, or the like on a network. For example, the registration request for document data is received, the processor 11 of the server 1 receives document data for which registration is requested and performs a registration process of storing the received document data into the data storage device 14. In addition, the document data may be directly input to the server 1 through a storage medium.

Further, a distribution request for document data is received (YES in ACT14), the processor 11 performs the distribution process of distributing the document data (ACT15). For example, the processor 11 of the server 1 receives a distribution request for document data for distribution from the devices such as the PC 2 or the tablet terminal 3 on a network. If the distribution request for document data is received, the processor 11 of the server 1 reads the document data, for which distribution is requested, from the data storage device 14, and performs the distribution process of delivering the read document data to a device in a distribution destination.

Further, if there is data to be synthesized in the document data for which distribution is requested, the processor 11 distributes an image which has been subjected to a synthesize process. For example, if there are stroke data of the write line and stroke data of the erase line, which correspond to the document data, the processor 11 distributes an image obtained by synthesizing the stroke data and the document data.

Further, if a recording request for stroke data for the document data is received (YES in ACT16), the processor 11 performs the recording process of recording the stroke data in correlation with the document data (ACT17). The processor 11 of the server 1 receives stroke data of the write line indicating a write line to be drawn in the document data for distribution and stroke data of the erase line for the write line drawn in the document data from the PC 2, the tablet terminal 3, or the like. If the stroke data of the document data for distribution is received, the processor 11 stores the received stroke data in correlation with the document data in the data storage device 14.

Further, if an output request for a file of a general-purpose format of the document data is received (YES in ACT18), the processor 11 generates the file of the general-purpose format from the document data and performs the output process of outputting the generated file of the general-purpose format (ACT19). For example, the processor 11 of the server 1 receives the output request for the file of the general-purpose format from the devices such as the PC 2, the tablet terminal 3, or the like on the network. If the output request for the file of the general-purpose format is received, the processor 11 of the server 1 synthesizes the document data for which an output is requested and the stroke data corresponding to the document data, and generates a file of the designated general-purpose format from the synthesized data so as to transmit the generated file of the general-purpose format to the device in an output request source.

Further, if a print output request for document data is received (YES in ACT20), the processor 11 generates image data for printing from the document data and performs an output process of outputting the generated image data for printing (ACT21). For example, the processor 11 of the server 1 receives the print output request of document data from the multifunction device 5. If the print output request is received, the processor 11 synthesizes the document data for which a printing output is requested and the stroke data corresponding to the document data, and generates image data for printing to transmit the generated image data for printing to the multifunction device 5 in the output request source.

The processor 11 of the server 1 repeatedly performs the processes described above until a program for a distribution system is terminated. If the program for the distribution system is terminated (YES in ACT22), the processor 11 terminates the processes described above.

Next, a function of drawing a line on document data which is displayed on a user terminal such as the PC 2 or the tablet terminal 3 and a function of erasing the drawn line will be described.

The user terminal such as the PC 2 or the tablet terminal 3 having a display device equipped with a touch panel has a function of displaying the document data managed by the server 1, a write function (pen function) of writing a line into a displayed image, and an erase function (eraser function) of erasing the line written by the write function and the like. The pen function and the erase function are achieved by the touch panel detecting a portion touched by the user on the display screen.

A line (write line) to which writing is instructed by the pen function is saved as stroke data indicated by a plurality of through points. Further, a line (erase line) to which erasing is instructed by the eraser function is saved as stroke data indicated by a plurality of through points.

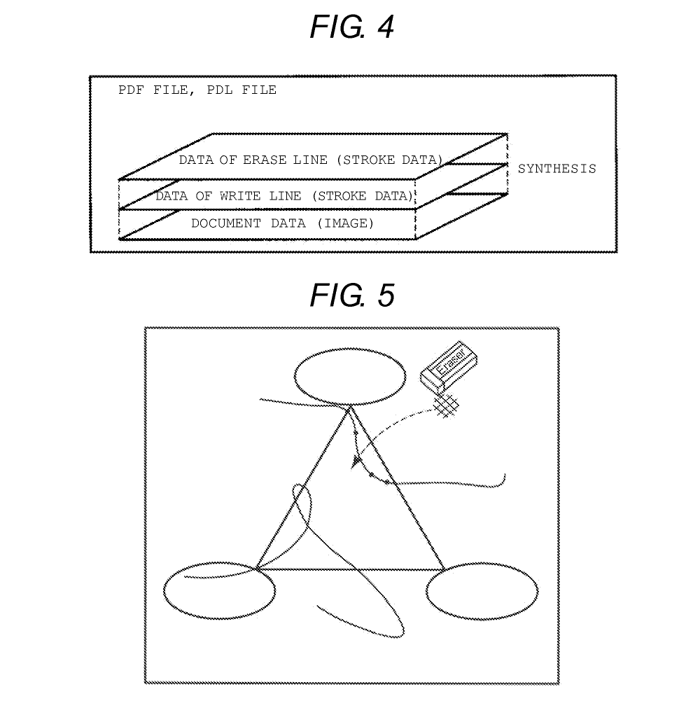

FIG. 4 is a schematic diagram illustrating a synthesis of a write line and an erase line for an image of document data.

In the example illustrated in FIG. 4 illustrates an example in which the stroke data of the write line and the stroke data of the erase line are superimposed on the image of the document data and synthesized.

For example, an image on which the write line is drawn on an image of document data is generated by superimposing the stroke data of the write line on the image of the document data and synthesizing the data. Further, an image in which the write line is erased based on the erase line is generated by superimposing the stroke data of the erase line on the image in which the write line has been drawn on the image of the document data and synthesizing them.

Therefore, in the distribution system S, the document data, the stroke data of the write line corresponding to the document data and the stroke data of the erase line are associated and managed. In other words, the server 1 manages the stroke data of the write line and the stroke data of the erase line in correlation with the document data, and manages a layer for each stroke data. Thus, the stroke data of the write line and the stroke data of the erase line are superimposed on the image of the document data managed by the server 1 in a plurality of layers and synthesized, thereby enabling an image in which a line is drawn on the image of the document data to be generated.

FIG. 5 is a diagram illustrating an example of erasing a portion of a line drawn on a display screen of document data using the eraser function.

As illustrated in FIG. 5, the PC 2 or the tablet terminal 3 may draw a line on a screen of a display device which displays document data through the pen function. In other words, the PC 2 or the tablet terminal 3 performing the pen function detects a portion touched by the user on the display screen by the touch panel and writes the detected portion as a line on the display image. The PC 2 or the tablet terminal 3 may erase the line drawn on the image of the document data by the eraser function. The PC 2 or the tablet terminal 3 performing the eraser function detects a portion touched by the user on the display screen by the touch panel and takes the detected portion as an erase line. If the erase line intersects the drawn line (write line), the PC 2 or the tablet terminal 3 erases the line in the intersected portion.

The write line written by the pen function is managed as the stroke data of the write line indicated by a plurality of through points, and the erase line to which erasing is instructed by the eraser function is managed as the stroke data of the erase line indicated by a plurality of through points. Here, if the write line and the erase line are managed as pixel data, data amount is increased and thus it is not suitable for data received and transmitted over a network and for data stored in files. Therefore, in the distribution system S according to the present embodiment, the write line and erase line are managed as the stroke data indicated by the plurality of through points.

Further, when the write line and the erase line are managed as the stroke data, the wider an interval between through points becomes, the smaller the data amount becomes. However, in an erase process of specifying an area in which the erase line intersects the write line only by an area between through points and erasing the area, as an interval between the through points becomes wider, a range wider than a width of the erase line is erased, which induces a reduction in accuracy.

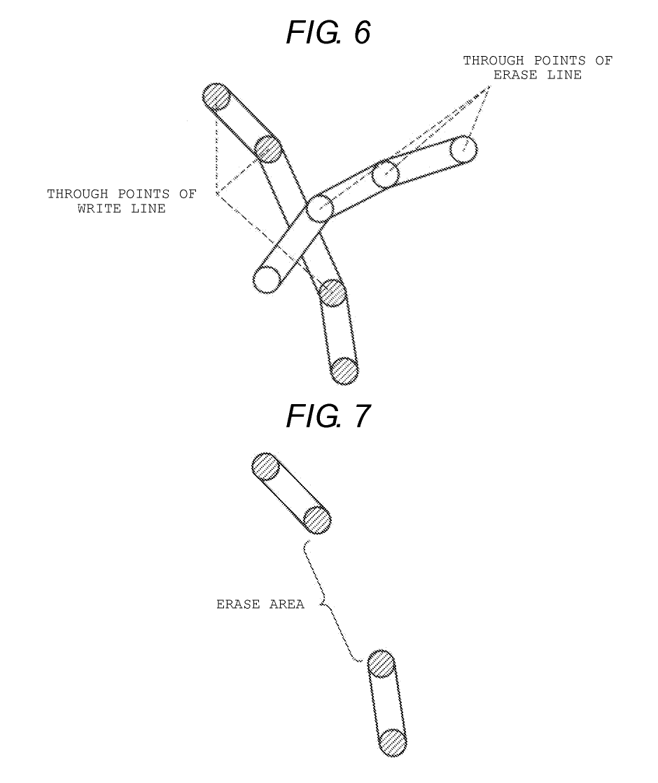

FIG. 6 is a diagram illustrating a relationship between the write line and the erase line. FIG. 7 is a diagram illustrating a case of performing the erase process only by the through points illustrated in FIG. 6.

As illustrated in FIG. 6 and FIG. 7, when the interval between through points of the write line is greater than the width of the erase line, if an area in which the write line and the erase line intersect (erase area) is specified by an area between through points, an area to be erased in the write line is greater than the width of the erase line. In such a case, since a part which the user does not intend to actually erase is also erased, the user feels uncomfortable.

The distribution system S according to the present embodiment adds relay points between through points in addition to original through points which define a write line. Thus, the area (erase area), in which the write line and the erase line intersect, is specified with high accuracy, and thus an accurate erase process is performed. Further, the distribution system S according to the present embodiment adds relay points between through points in addition to the original through points even in the erase line.

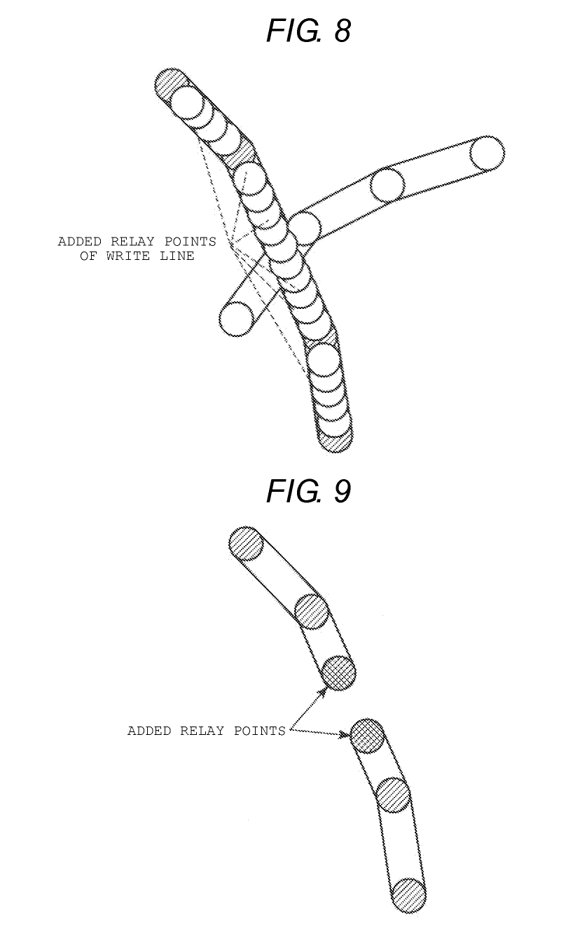

FIG. 8 is a diagram illustrating a case in which relay points are added in the write line. FIG. 9 is a diagram illustrating a case of performing the erase process of specifying the erase area by the through points and the relay points illustrated in FIG. 8.

As illustrated in FIG. 8 and FIG. 9, even when the interval between the through points in the write line is wider than the width of the erase line, if an area intersecting the erase line (erase area) is specified by an area between the through points and the relay points in the write line, the erase area in the write line is close to the width of the erase line. In other words, even when the interval between the through points of the write line and the erase line is set to wide in order to reduce the data amount of the stroke data, it is possible to specify the erase area in the write line with high accuracy and to achieve the erase process from which the user does not feel uncomfortable by compensating the area between through points in the write line and the erase line with a plurality of relay points.

In the distribution system S according to the present embodiment, the server 1 manages the original document data, the stroke data of the write line correlated with the document data and the stroke data of the erase line. Therefore, when the document data is distributed, the generation of a file of a general-purpose format of the document data is requested and printing of the document data is requested, the server 1 performs a process of synthesizing the stroke data of the write line and the stroke data of the erase line and the document data to be distributed.

Next, a process of generating a file of a general-purpose format of the document data managed by the server 1 will be described.

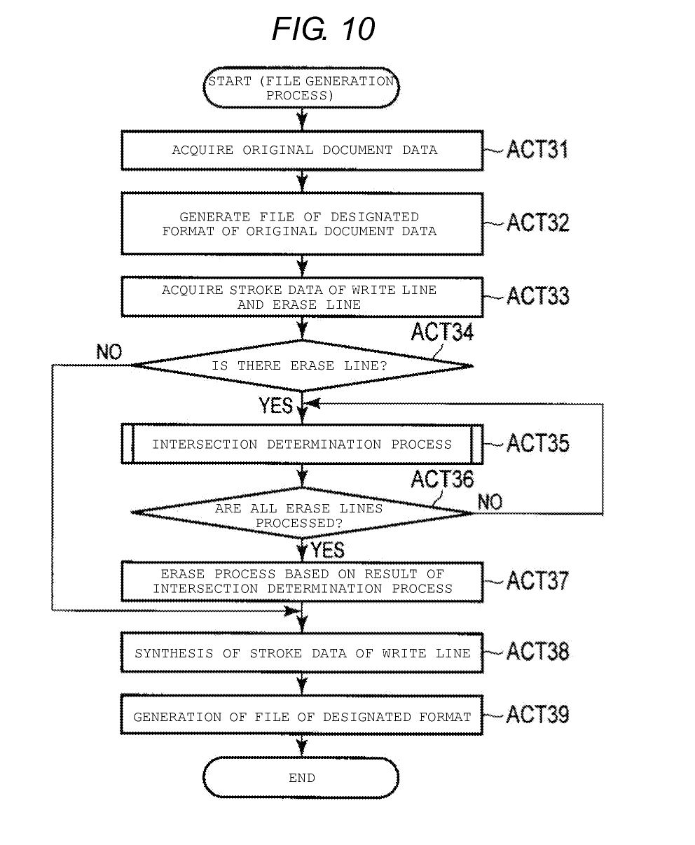

FIG. 10 is a flow chart illustrating a process of generating a file of a general-purpose format of the document data.

First, it is assumed that the generation of a file of a general-purpose format of certain document data is requested. If the generation of the file is requested, the processor 11 of the server 1 acquires original document data of the designated document data from the document data registered as the document data for distribution by the distribution system S (ACT31). For example, the processor 11 reads the designated original document data from the data storage device 14. In addition, the processor 11 may acquire the original document data from an external device through the network 6 or the like. If the original document data is acquired, the processor 11 converts the acquired original document data into a file of a general-purpose format (for example, a Portable Document Format (PDF) file) (ACT32).

If the original document data is converted into the file of the general-purpose format, the processor 11 acquires stroke data corresponding to the document data (ACT33). For example, the processor 11 reads the stroke data of the write line corresponding to the document data and the stroke data of the erase line from the data storage device 14. ACT33 corresponds to an acquisition section. If the stroke data is acquired, the processor 11 determines whether the stroke data of the erase line is included in the acquired stroke data (ACT34).

When it is determined that there is the stroke data of the erase line (YES in ACT34), the processor 11 performs an intersection determination process of erasing an area intersecting the erase line in the write line (ACT35). ACT34 corresponds to an intersection determination section. The intersection determination process will be described in detail later. Here, as a result of the intersection determination process, it is assumed that two boundary points which become a boundary between the area intersecting the erase line and the other areas in the write line are obtained.

If the intersection determination process of the stroke data of a certain erase line is completed, the processor 11 determines whether the intersection determination process has been performed for all erase lines (ACT36). When it is determined that there is an erase line which has not been subjected to the intersection determination process (NO in ACT36), the processor 11 performs the intersection determination process on the stroke data of the erase line which has not been subjected to the intersection determination process. In addition, it is assumed that the intersection determination process is performed for respective images (image in a unit of a page) constituting the document data.

When it is determined that the intersection determination process for all erase lines is completed, (YES in ACT36), the processor 11 performs the erase process for the write line based on the result of the intersection determination process (ACT37). For example, when boundary points indicating an area intersecting the erase line in the write line are obtained as a result of the intersection determination process, the processor 11 erases the line (data) present between the boundary points which form the area intersecting the erase line in the write line, as the erase process. ACT37 corresponds to an erase section.

When the erase process for the write line is performed based on the result of the intersection determination process, the processor 11 synthesizes the stroke data of the write line which has been subjected to the erase process and the image (data for display) of the original document data (ACT38). Further, when it is determined that there is no erase line (YES in ACT34), the processor 11 synthesizes the acquired stroke data of the write line and the image (image data for display) of the original document data (ACT38).

In addition, even when relay points other than the original through points are added (generated) to the stroke data of the write line and the erase line in the intersection determination process which will be described later, it is assumed that the stroke data of the write line and the erase line is managed by the original through points which do not include the relay points added in the intersection determination process which will be described later. Thus, the addition (generation) of the relay points may prevent the data amount of the stroke data of the write line and the erase line from being increased.

If the stroke data of the write line and the original document data are synthesized, the processor 11 generates an image of document data including lines drawn by the pen function and lines of which a portion is erased by the eraser function as the file of the general-purpose format by adding parameters necessary for a synthesized file (ACT39).

The file of the general-purpose format of the document data generated by the above process is output to the PC 2, the tablet terminal 3, or the like. Further, the process of generating data for printing may be also achieved in the same sequence as the process illustrated in FIG. 10. For example, when the printing request is received from the multifunction device 5, the server 1 may generate a file for printing of the designated document data according to the process sequence illustrated in FIG. 10 and output the generated file data for printing to the multifunction device 5.

Next, the intersection determination process (erase process) of determining an area intersecting the erase line (erase area) in the write line will be described.

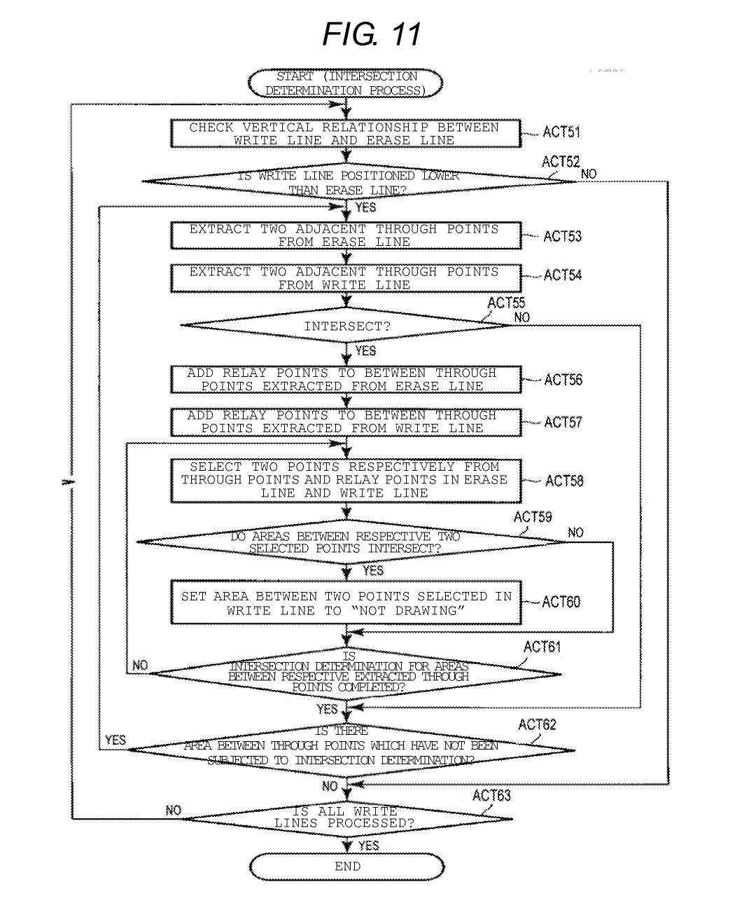

FIG. 11 is a flow chart illustrating a flow of an intersection determination process for the erase line corresponding to certain document data.

When the stroke data of the erase line corresponding to certain document data is acquired, the processor 11 of the server 1 starts the intersection determination process. If the intersection determination process is started, the processor 11 specifies the stroke data of the write line corresponding to the document data and checks a vertical relationship between the write line and the erase line (ACT51). For example, the processor 11 checks the vertical relationship by comparing layer information of the stroke data of the write line with layer information of the stroke data of the erase line.

When it is determined that the write line is positioned on a lower side than the erase line, that is, it is determined that the erase line is superimposed on the write line (YES in ACT52), the processor 11 extracts two adjacent through points in the stroke data of the erase line (ACT53). Further, the processor 11 extracts two adjacent through points also in the stroke data of the write line (ACT54). If the respective two adjacent through points in the erase line and the write line are extracted, the processor 11 determines whether an area between the two adjacent through points extracted from the erase line and an area between the two adjacent through points extracted from the write line intersect as a primary intersection determination (ACT55). When it is determined that the areas between the adjacent through points respectively extracted from the erase line and the write line do not intersect (NO in ACT55), the processor 11 proceeds to ACT62 and determines whether there is an area between through points which have not been subjected to the intersection determination.

In addition, in a process which will be described later, since the intersection determination is performed for the area between two adjacent points including relay points added to between the through points, the intersection determination (primary intersection determination) between the through points may be omitted. However, a process such as the addition of relay points or the intersection determination for a plurality of areas between two points including the relay points may be omitted for an area between through points which is determined as not intersecting by determining the presence or absence of the intersection between the through points as the primary intersection determination, and thus speeding up the process.

When it is determined that the areas between the adjacent through points respectively extracted from the erase line and the write line intersect (YES in ACT55), the processor 11 adds relay points between through points extracted from the erase line (ACT56), and adds relay points also between through points extracted from the write line (ACT57). The relay point may be added at each predetermined interval between the through points, and relay points of a predetermined number may be added between the extracted through points.

In addition, it is assumed that the added relay points are data used only for performing the intersection determination process, and do not affect the original through points in the stroke data of the erase line and the stroke data of the write line. This prevents the data amount of the stroke data of the erase line and the stroke data of the write line from being increased. However, when the erase area of a line is specified based on the added relay points, the relay points indicating the erase area are added to the stroke data of the write line.

If the relay points are added between the extracted through points of the erase line and the write line, the processor 11 selects two points which are objects of the intersection determination from the through points and the relay points in the erase line, and selects two points which are objects of the intersection determination also from the through points and the relay points in the write line (ACT58). With respect to the two points in the erase line and the write line, the processor 11 may select two adjacent points in order from one through point side at a time and determine the presence or absence of intersection in order, or may select two points at a time in order from a side close to both through points and refine an intersecting boundary. In other words, a method of selecting two points which are objects of the intersection determination from the erase line and the write line may be a selection capable of detecting two points (relay points or through points) which intersect between through points and form a boundary. Here, it is assumed that respective two adjacent points in the erase line and the write line are sequentially selected.

If respective two points are selected in the erase line and the write line, the processor 11 determines whether the respective two points selected in the erase line and the two points selected in the write line intersect (ACT59). When it is determined that the areas between the respective two points selected in the erase line and the write line intersect by the intersection determination (YES in ACT59), the processor 11 sets the line as “not to be drawn (that is, erase)” for the area between the two points selected in the write line (ACT60).

After the line is set as “not to be drawn” since the area between the two points selected in the erase line and the write line to intersect, or when it is determined that the area between the two points selected in the erase line and the write line do not intersect (NO in ACT59), the processor 11 determines whether the intersection determination for all areas between the respective through points extracted from the erase line and the write line is completed (ACT61). When it is determined that the intersection determination between the extracted through points is not completed (NO in ACT61), the processor 11 returns to ACT58 and selects two separate points so as to perform the process of ACTS 58 to 61.

Further, when it is determined that the intersection determination between the extracted through points is completed (YES in ACT61), the processor 11 determines whether there is an area between the through points which have not been subjected to the intersection determination (ACT62). When it is determined that there is an area between the through points which have not been subjected to the intersection determination (YES in ACT62), the processor 11 returns to ACTS 53 and 54, and extracts an area between two through points which have not been subjected to the intersection determination from the erase line and the write line so as to perform the process of ACTS 53 to 62.

Further, when it is determined that there is no area between the through points which have not been subjected to the intersection determination (YES in ACT62), the processor 11 returns to the ACTS 53 and 54, and determines whether the intersection determination process with the erase line for all the write lines has been completed (ACT63). When it is determined that there is a write line which has not been subjected to the intersection determination process (NO in ACT63), the processor 11 returns to ACT51, and performs the intersection determination process for the write line which has not been subjected to the intersection determination process with the erase line. When it is determined that there is no write line which has not been subjected to the intersection determination process (YES in ACT63), the processor 11 terminates the intersection determination process.

Next, an example of the intersection determination after the relay points are added to the write line and the erase line will be described.

In the process described above, the process in which the processor 11 determines whether the areas between two points including the relay points in the write line and the erase line intersect has been described. If the interval between the relay point and the through point is reliably smaller than the widths of the write line and the erase line (the diameter of a circle forming the write line and the erase line), the processor 11 may determine the presence or absence of the intersection for each point of the write line and the erase line. When the presence or absence of the intersection for each point of the write line and the erase line is determined, the processor 11 may detect the points which become a boundary of the presence or absence of the intersection with the erase line in the write line.

In addition, when the presence or absence of the intersection is determined at each point of the write line and the erase line, as with ACTS 58 to 61 illustrated in the process of FIG. 11, the presence or absence of the intersection is determined at each point of the write line and the erase line, two points (boundary points) which become a boundary of the presence or absence of the intersection in the write line are detected, and the area between the boundary points in the write line may be set to “not to be drawn”.

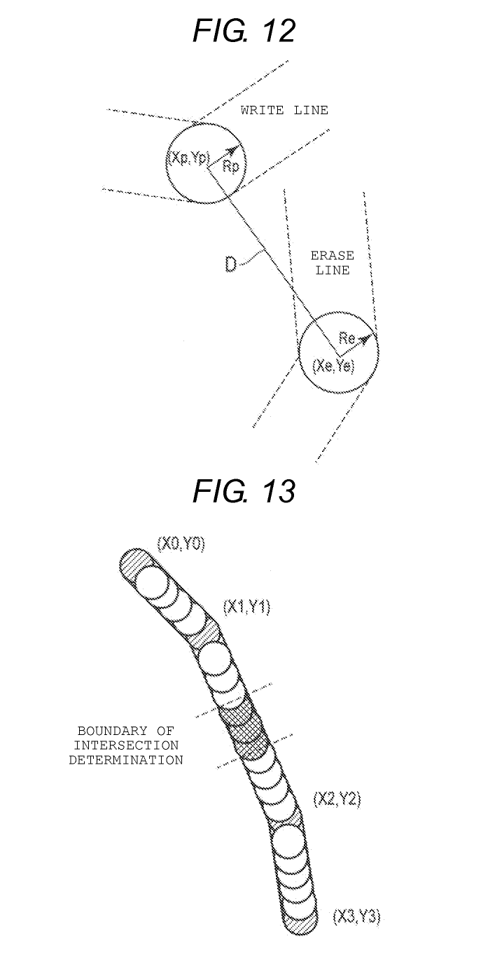

FIG. 12 is a diagram illustrating a relationship example between the point in the write line and the point in the erase line.

In the example illustrated in FIG. 12, the coordinate of the point (through point or relay point) in the write line is set to (Xp, Yp), the radius representing the width of the write line is set to Rp, the coordinate of the point (through point or relay point) in the erase line is set to (Xe, Ye), and the radius representing the width of the erase line is set to Re.

In this case, a distance D between the point of the write line and the point of the erase line is represented as Equation 1.

D=\sqrt{(Xe−Xp)²+(Ye−Yp)²} [Equation 1]

When the distance D is smaller than the sum of a thickness Rp of the write line and a thickness Re of the erase line, if a condition of D<(Re+Rp) is satisfied, it may be determined that the point of the write line intersects the erase line.

The processor 11 may find boundaries in which the result of the intersection determination differs by performing the intersection determination at each such a point for all through points and relay points. In this case, the points (relay points or through points) which become a boundary of the presence or absence of the intersection becomes a boundary between a portion of the line to be erased by the erase line and the remaining portion.

FIG. 13 is a diagram illustrating through points and relay points in the write line.

In the example illustrated in FIG. 13 illustrates points that are determined as intersecting and points that are determined as not intersecting by the intersection determination. In the example illustrated in FIG. 13, cross-hatched circles represent points that are determined as “intersecting”, white circles represent points that are determined as “not intersecting”, and hatched lines represent a boundary in which the result of the intersection determination differs. According to the result of the intersection determination illustrated in FIG. 13, two boundary points which become the boundary in which the result of the intersection determination differs in the write line may be detected.

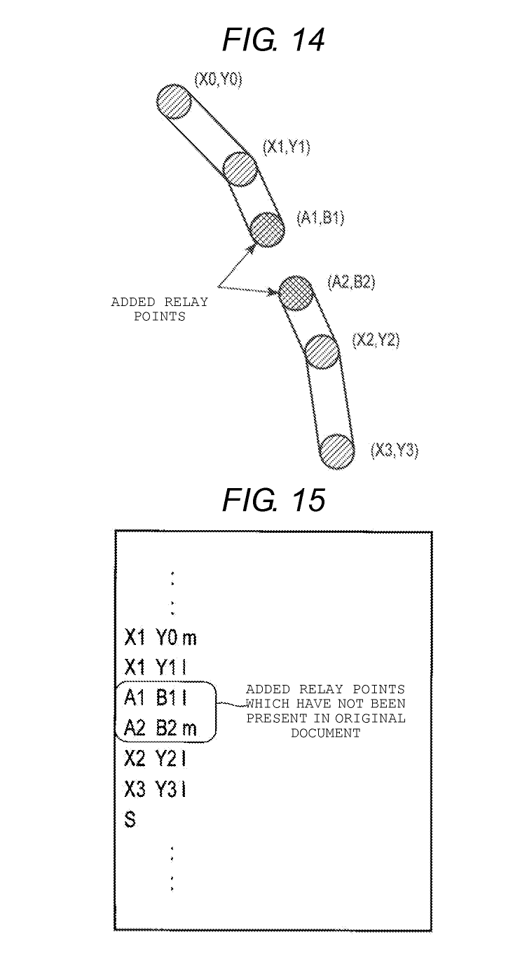

FIG. 14 is a diagram illustrating an example in which the added relay points become the boundary points of the intersection determination. In the example illustrated in FIG. 14, the line between the boundary points is erased. FIG. 15 is a diagram illustrating a description example of the file of the general-purpose format (for example, a PDF file) including the boundary points illustrated in FIG. 14. In the example illustrated in FIG. 15, relay points (A1, B1) and (A2, B2) which become boundary points which are not present in the through points defining the original stroke data are added. Further, in the example illustrated in FIG. 15, an area between the points (A1, B1) and (A2, B2) is set to “not to be drawn” in a drawing command.

In addition, an erase process of erasing a line present in an erase area formed with an area between the boundary points is performed by performing an intersection determination process using the relay points similarly to the example illustrated in FIG. 15 even for a Page Description Language (PDL) file which is data for printing as the file of the general-purpose format.

As described above, in the distribution system S of the present embodiment, in an erase method of erasing a line drawn with a pen write and drawing a trajectory in such a manner that the stroke data of an eraser by the eraser function (vector data to erase the line) is superimposed on the stroke data of write in the pen function (vector data to draw a line), the intersection determination is performed by providing relay points for performing the intersection determination between through points N constituting the stroke data of the pen write and next through points N+1, and a boundary in which the result of the intersection determination varies is detected and taken as boundary points.

Thus, according to the present embodiment, it is possible to detect the boundary points which become a boundary of the intersection determination (erase area determination) with high accuracy from not only the original through points but also relay points compensated between the original through points. As the result, it is possible to achieve the erase process of line with high accuracy without increasing data in the stroke data of the write line or the erase line. Further, according to such a process, even when stroke data for drawing a line by being superimposed on the document data and the stroke data for erasing the line are superimposed on a plurality of layers and displayed by being synthesized, it is possible to draw a line in which the result of drawing and erasing of a line is accurately reproduced.

In addition, in the embodiment described above, an example in which the server implements the process such as the file generation process and the intersection determination process has been described, but some or all of the processes as described above may be implemented in any device as long as the device is a device in the distribution system S having a processor and a memory which is connected to the network 6. For example, the process such as the file generation process and the intersection determination process described above may be implemented by the PC 2, the tablet terminal 3, the multifunction device 5, or the like.

A case in which the implemented functions are recorded inside the apparatus in advance has been described in the present embodiment, but without being limited thereto, the same functions may be downloaded into the apparatus from the network, and a recording medium storing the same functions may be installed in the apparatus. As long as the recording medium is a recording medium such as a CD-ROM which may store a program and which may be read by an apparatus, the form may be any form. Further, the functions obtained through installation or downloading in advance in this manner may be achieved in cooperation with an operating system (OS) or the like inside the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document data distribution system comprising:
a distribution unit configured to distribute document data;
an acquisition section configured to acquire a plurality of through points representing a write line drawn to be overlaid on the document data and a plurality of through points representing an erase line for erasing portions of the write line drawn to be overlaid on the document data;
an intersection determination section configured to add a relay point between the through points of the write line and determine two of the through points and relay points of the write line as boundary points of an intersection area where the erase line intersects with the write line; and
an erase section configured to erase portions of the write line that are between the boundary points.

2. The system according to claim 1,
wherein the intersection determination section is further configured to add a relay point between the through points of the erase line.

3. The system according to claim 1,
wherein the intersection determination section is further configured to determine a presence or absence of an intersection between through points of the write line and through points of the erase line, and determine the intersection area to include an area between the through points of the write line and the through points of the erase line for which the presence of the intersection has been determined.

4. The system according to claim 1,
wherein the intersection determination section is further configured to determine a presence or absence of an intersection between adjacent through points and relay points of the write line and adjacent through points of the erase line, and determine the intersection area to include an area between the adjacent through points and relay points of the write line and the adjacent through points of the erase line for which the presence of the intersection has been determined.

5. The system according to claim 4, wherein the adjacent through points and relay points of the write line are determined as the boundary points.

6. The system according to claim 1, further comprising a display unit configured to display the document data and an input device through which the write line and the erase line are input.

7. The system according to claim 6, wherein the input device comprises a touch screen that is integrated with the display unit.

8. The system according to claim 1, further comprising a server configured with the acquisition section, the intersection determination section, and the erase section and connected to the input device over a network.

9. The system according to claim 8, wherein the server comprises a processor configured to execute a program, and a memory into which the program is loaded, wherein the acquisition section, the intersection determination section, and the erase section are parts of the program executed by the processor.

10. The system according to claim 9, wherein the server further comprises a communication device connected to the network by which data representing the write line and the erase line are received.

11. A method of managing edits to document data distributed over a network, said method comprising:
distributing the document data over the network and receiving edits to the document data over the network, the edits including a write line drawn to be overlaid on the document data and an erase line for erasing portions of the write line drawn to be overlaid on the document data;
acquiring a plurality of through points representing the write line and a plurality of through points representing the erase line;
adding a relay point between the through points of the write line and determining two of the through points and relay points of the write line as boundary points of an intersection area where the erase line intersects with the write line; and
erasing portions of the write line that are between the boundary points.

12. The method according to claim 11, further comprising:
adding a relay point between the through points of the erase line.

13. The method according to claim 11, further comprising:
determining a presence or absence of an intersection between through points of the write line and through points of the erase line; and
determining the intersection area to include an area between the through points of the write line and the through points of the erase line for which the presence of the intersection has been determined.

14. The method according to claim 11, further comprising:
determining a presence or absence of an intersection between adjacent through points and relay points of the write line and adjacent through points of the erase line, and
determining the intersection area to include an area between the adjacent through points and relay points of the write line and the adjacent through points of the erase line for which the presence of the intersection has been determined.

15. The method according to claim 14, wherein the adjacent through points and relay points of the write line are determined as the boundary points.

16. A non-transitory computer readable medium comprising instructions, which when executed in a computing device that is connected to a network, carries out a method of managing edits to document data distributed over the network, said method comprising:
distributing the document data over the network and receiving edits to the document data over the network, the edits including a write line drawn to be overlaid on the document data and an erase line for erasing portions of the write line drawn to be overlaid on the document data;
acquiring a plurality of through points representing the write line and a plurality of through points representing the erase line;
adding a relay point between the through points of the write line and determining two of the through points and relay points of the write line as boundary points of an intersection area where the erase line intersects with the write line; and
erasing portions of the write line that are between the boundary points.

17. The non-transitory computer readable medium according to claim 16, wherein the method further comprises:
adding a relay point between the through points of the erase line.

18. The non-transitory computer readable medium according to claim 16, wherein the method further comprises:
determining a presence or absence of an intersection between through points of the write line and through points of the erase line; and
determining the intersection area to include an area between the through points of the write line and the through points of the erase line for which the presence of the intersection has been determined.

19. The non-transitory computer readable medium according to claim 16, wherein the method further comprises:
determining a presence or absence of an intersection between adjacent through points and relay points of the write line and adjacent through points of the erase line, and
determining the intersection area to include an area between the adjacent through points and relay points of the write line and the adjacent through points of the erase line for which the presence of the intersection has been determined.

20. The non-transitory computer readable medium according to claim 19, wherein the adjacent through points and relay points of the write line are determined as the boundary points.
